(19) United States
(12) Patent Application Publication
(10) Pub. No.: US 2018/0063282 A1
(43) Pub. Date: Mar. 1, 2018

(54) GENERATING AUTOMATIC RESPONSES TO REQUESTS FOR INFORMATION

(71) Applicant: LENOVO ENTERPRISE SOLUTIONS (SINGAPORE) PTE. LTD., Singapore (SG)

(72) Inventors: JOHN S. CROWE, DURHAM, NC (US); GARY D. CUDAK, WAKE FOREST, NC (US); JENNIFER J. LEE-BARON, MORRISVILLE, NC (US); NATHAN J. PETERSON, DURHAM, NC (US); AMY L. ROSE, CHAPEL HILL, NC (US); BRYAN L. YOUNG, TUALATIN, OR (US)

(21) Appl. No.: 15/250,046

(22) Filed: Aug. 29, 2016

(51) Int. Cl. H04L 29/08

(52) U.S. Cl. CPC H04L 67/327; H04L 67/10

(57) ABSTRACT

Generating automatic responses to requests for information, including: receiving, by a receiving device from a requesting device, a message; determining, in dependence upon content contained in the message and ambient data associated with the receiving device, whether to engage an automated response system; and responsive to determining to engage the automated response system, sending a response to the requesting device.

### BACKGROUND

### Field of the Invention

The field of the invention is data processing, or, more specifically, methods, apparatus, and products for generating automatic responses to requests for information.

### Description of Related Art

Modern computing devices are often equipped with hardware and software that enables users of the computing devices to communicate. Such communications can include a user of a first computing device requesting some information from a user of a second computing device. For example, the user of a first smartphone may send a text message to the user of a second smartphone, where the text message includes a question that requires a response from the user of the second smartphone. Responding to such messages, however, may be dangerous in some situations (e.g., while driving) or impractical in other situations (e.g., the user is in a meeting).

### SUMMARY

Methods, apparatuses, and products for generating automatic responses to requests for information, including: receiving, by a receiving device from a requesting device, a message; determining, in dependence upon content contained in the message and ambient data associated with the receiving device, whether to engage an automated response system; and responsive to determining to engage the automated response system, sending a response to the requesting device.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a block diagram of automated computing machinery comprising an example computing device configured for generating automatic responses to requests for information according to embodiments of the present disclosure.

FIG. 2 sets forth a flow chart illustrating an example method for generating automatic responses to requests for information according to embodiments of the present disclosure.

FIG. 3 sets forth a flow chart illustrating an additional example method for generating automatic responses to requests for information according to embodiments of the present disclosure.

FIG. 4 sets forth a flow chart illustrating an additional example method for generating automatic responses to requests for information according to embodiments of the present disclosure.

FIG. 5 sets forth a flow chart illustrating an additional example method for generating automatic responses to requests for information according to embodiments of the present disclosure.

### DETAILED DESCRIPTION

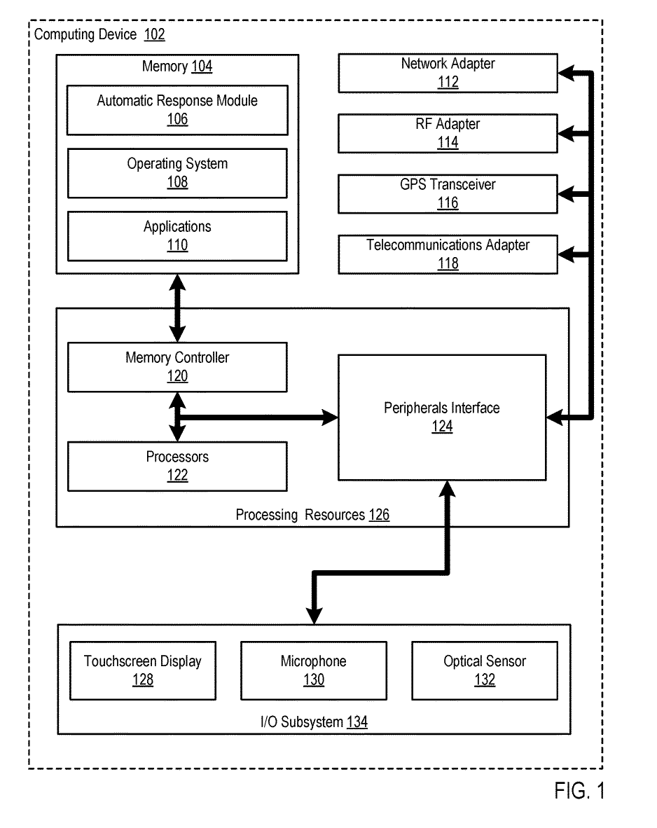

Example methods, apparatus, and products for generating automatic responses to requests for information in accordance with the present disclosure are described with reference to the accompanying drawings, beginning with FIG. 1. FIG. 1 sets forth a block diagram of automated computing machinery comprising an example computing device (102) configured for generating automatic responses to requests for information according to embodiments of the present disclosure. Readers will appreciate that the computing device (102) depicted in FIG. 1 may be embodied, for example, as a tablet computer, as a laptop computer, as a smartphone, as an e-reader, as a smartwatch, as some other form of portable electronic device, and so on.

The computing device (102) depicted in FIG. 1 includes processing resources (126). The processing resources (126) depicted in FIG. 1 may be embodied, for example, on a single chip or as a collection of chips. The processing resources (126) can include one or more processors (122) which may be embodied, for example, as one or more central processing units (‘CPUs’) as well as one or more memory controllers (120) that couple the processing resources (126) to computer memory (104). Such computer memory (104) may be embodied, for example, as random access memory (“RAM”), flash memory, non-volatile random access memory, and so on, as well as other combinations of various types of computer memory.

The computer memory (104) depicted in FIG. 1 includes an operating system (108). Operating systems useful in computing devices configured for generating automatic responses to requests for information according to embodiments described herein include Apple iOS™, Android OS, Microsoft Windows Mobile™, and others as will occur to those of skill in the art. The computer memory (104) depicted in FIG. 1 also includes one or more applications (110). The one or more applications (110) may include modules of computer program instructions that, when executed by processing resources (126) in the computing device (102), cause the computing device (102) to carry out various functions. Such applications (110) can carry out a wide array of functions and may be embodied, for example, as a calendar application that is used to track a user's appointments, as a mapping application that is used to provide a user with directions from a starting point to a destination, as an application for storing a list of contacts, as a video conferencing application, as an email client application, as a text messaging application, as an instant messaging application, and many others as will occur to those of skill in the art.

The computer memory (104) depicted in FIG. 1 also includes an automatic response module (126), a module of computer program instructions for generating automatic responses to requests for information according to embodiments of the present disclosure. The automatic response module (126) may be configured for generating automatic responses to requests for information by: receiving, from a requesting device, a message; determining, in dependence upon content contained in the message and ambient data associated with the computing device, whether to issue an automated response; responsive to determining to issue an automated response, sending the automated response to the requesting device; determining whether a user of the computing device is unavailable to respond to the message; determining whether the message requests a response; generating, in dependence upon the content contained in the message, the automated response; generating, in dependence upon data maintained by the computing device, the automated response; gathering ambient data associated with the computing device; and performing other functions as will be described in greater detail below.

The processing resources (126) depicted in FIG. 1 also includes a peripherals interface (124) that couples input peripherals and output peripherals in the computing device (102) to the processors (122) and the memory controller (120). Such a peripherals interface may be embodied as electronic circuitry used to exchange digital signals between input peripherals and output peripherals in the computing device (102) and the processors (122) and the memory controller (120) in the computing device (102). In the example depicted in FIG. 1, the peripherals interface is coupled to devices such as a network adapter (112) for facilitating data communications between the computing device (102) and other computing devices over data communications networks as IP-based data communications networks, a radio frequency (‘RF’) adapter (114) for short range data communications with other computing devices, a global positioning system (‘GPS’) transceiver (116) for receiving location information for the computing device (102), as a telecommunications adapter (118) for telecommunications with other telecommunications devices, and so on.

The peripherals interface (124) of FIG. 1 also couples an input/output (‘I/O’) subsystem (134) to the processors (122) and memory controller (120). Such an I/O subsystem (134) may include components such as a touchscreen display (128), a microphone (130), an optical sensor (132), and others as may occur to those of skill in the art. Readers will appreciate that computing devices configured for generating automatic responses to requests for information according to embodiments of the present disclosure may include communications mechanisms such as data communications busses and signal lines, as well many other software and hardware components, as will occur to those of skill in the art. Readers will further appreciate that while the computing device (102) includes applications (110) and the automatic response module (106), such components may be part of a larger system that is configured for data communications with the computing device (102). For example, the applications (110) and the automatic response module (106) may be executing on cloud-based resources that are configured for data communications with the computing device (102).

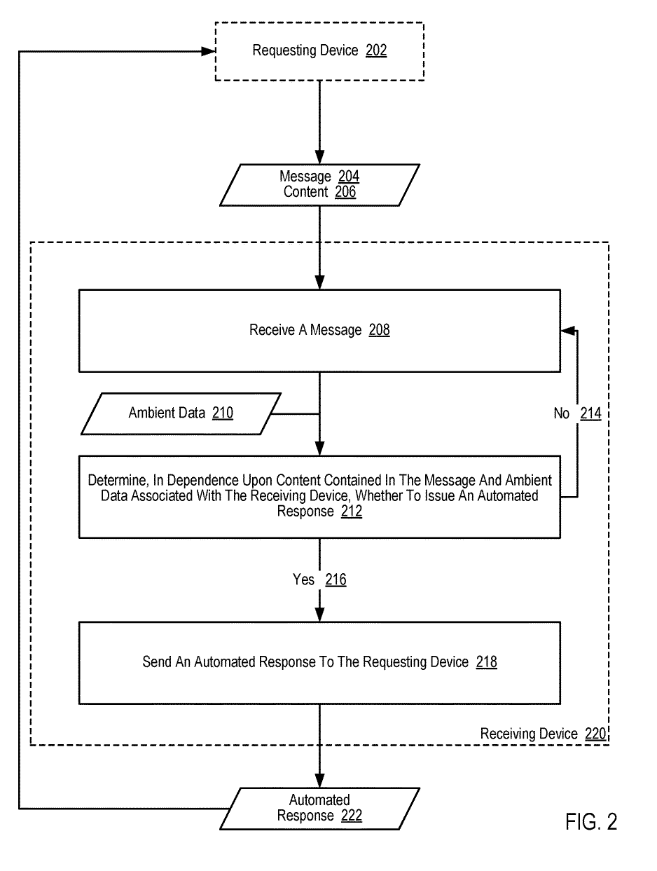

For further explanation, FIG. 2 sets forth a flow chart illustrating an example method for generating automatic responses to requests for information according to embodiments of the present disclosure. Generating automatic responses to requests for information may be carried out, for example, through the use of one or more modules of computer program instructions that are executing on computer hardware such as a computer processor. The one or more modules of computer program instructions may be executing on computer hardware that is contained within a receiving device (220). Such a receiving device (220) may be embodied, for example, as a smartphone, as a tablet computer, as a laptop computer, as some other form of a portable consumer electronic device, and so on.

The example method depicted in FIG. 2 includes receiving (208), by a receiving device (220) from a requesting device (202), a message (204). The requesting device (202) may be embodied, for example, as a smartphone, as a tablet computer, as a laptop computer, personal computer, or as some other form of device that is configured for data communications with the receiving device (220). The receiving device (220) may receive (208) the message (204) from the requesting device (202), for example, via one or more data communications networks that enable the requesting device (202) and the receiving device (220) to communicate, via a direct communications link that enables the requesting device (202) and the receiving device (220) to communicate, and so on. In such an example, the message (204) may be embodied in many forms. The message (204) may be embodied, for example, as a text message that is sent from the requesting device (202) to the receiving device (220), as an electronic mail message that is sent from an electronic mail application that is executing on the requesting device (202) to an electronic mail application that is executing on the receiving device (220), as another form of message that is sent from a messaging application that is executing on the requesting device (202) to a messaging application that is executing on the receiving device (220), as a voice message that is sent over a telecommunications network from the requesting device (202) to the receiving device (220), and so on.

Readers will appreciate that in some instances, the message (204) that is received (208) by the receiving device (220) may include a request for a response from a user of the receiving device (220). For example, the message may be embodied as a text message that includes a question such as “what time are you planning to be home?” Furthermore, in some embodiments the message (204) that is received (208) by the receiving device (220) may include a request for a response from a user of the receiving device (220) that is time-sensitive. For example, the message may be embodied as a text message that includes a question such as “can you give me a ride to my appointment that begins in 15 minutes?” In such an example, if the user of the receiving device (220) is unavailable, the user of the receiving device (220) may not issue a response to the message (204) in a timely manner.

The example method depicted in FIG. 2 also includes determining (212), in dependence upon content (206) contained in the message (204) and ambient data (210) associated with the receiving device (220), whether to issue an automated response. An automated response may be issued, for example, by an automated response system executing on the receiving device (220). The automated response system may be embodied, for example, as one or more modules of computer program instructions that are executing on computer hardware such as a computer processor. The one or more modules of computer program instructions may be executing on computer hardware that is contained within a receiving device (220). Readers will appreciate that the automated response system may be a standalone application or, alternatively, the automated response system may be part of a larger application such as an operating system, a data communications suite, and so on. In such an example, the automated response system may be configured to generate an automated response to a message (204) that is received (208) by the receiving device (220).

In the example method depicted in FIG. 2, determining (212) whether to issue an automated response is carried out in dependence upon content (206) contained in the message (204). The content (206) contained in the message (204) may be embodied, for example, as the words and sentences contained in a text message, as the words and sentences contained in an electronic message, as the words and sentences that are spoken in a voice message (which may be subsequently translated to text using voice-to-text translation techniques), and so on. In such an example, the content (206) contained in the message (204) may be examined to determine whether an automated response to the message (204) is requested.

Consider an example in which a first text message that is received by the receiving device (220) includes the following textual content (206): “What time are you planning to be home from work? I'm going to start dinner about 10 minutes after you leave the office.” In such an example, assume that a second text message that is received by the receiving device (220) includes the following textual content (206): “Your wireless bill in the amount of $75.83 is due in 10 days.” Readers will appreciate that a response to the first text message is requested while a response to the second text message is not requested. In such an example, by utilizing natural language processing techniques, the receiving device (220) may be able to distinguish incoming messages that request a response from incoming messages that do not request a response. The receiving device (220) may be able to distinguish incoming messages that request a response from incoming messages that do not request a response, for example, by determining whether punctuation included in the content (206) contained in the message (204) indicates that a question is being asked (e.g., a sentence ends in a question mark rather than a period), by determining whether words included in the content (206) contained in the message (204) indicates that a question is being asked (e.g., what, where, when), and so on. As such, determining (212) whether to issue an automated response may be carried out in dependence upon content (206) contained in the message (204) by examining the content (206) to determine whether a question is being asked. Determining (212) whether to engage the automated response system may similarly be carried out in dependence upon content (206) contained in the message (204) by examining the content (206) to determine whether some other form of a response is requested, such as a text message that includes the following textual content (206): “Please reply “yes” to confirm your reservation at Chili's.” In such an example, an automated response may only be issued when the content (206) contained in the message (204) indicates that a reply is requested.

In the example method depicted in FIG. 2, determining (212) whether to issue an automated response is also carried out in dependence upon ambient data (210) associated with the receiving device (220). The ambient data (210) associated with the receiving device (220) may include, for example, data gathered by the receiving device (220) that is indicative of whether a user of the receiving device (220) is likely to respond to the message (204). The ambient data (210) may include, for example, global positioning system (‘GPS’) data gathered by a GPS receiver in the receiving device (220). Such GPS data may indicate that the user is currently at a location where responding to messages (204) is determined to be less likely. Responding to messages (204) may be determined to be less likely, for example, based on the historical rate at which the user of the receiving device (220) has responded to messages while at the sensed location in the past, based on the nature of the sensed location (e.g., a church, a movie theater) of the user, and so on. Alternatively, such GPS data may indicate that the user is less likely to respond to messages (204) as the GPS data indicates that the receiving device (220) is travelling at a reasonably high rate of speed, thereby indicating that the user of the receiving device (220) may be driving.

Readers will appreciate that many other forms of ambient data (210) associated with the receiving device (220) may be used to determine a relative likelihood that the user of the receiving device (220) is less likely to respond to the message. For example, ambient data (210) associated with the receiving device (220) may take the form of information that is stored in a calendar application on the receiving device (220), as a user of the receiving device (220) may be less likely to respond to messages (204) received during a period of time when the calendar data indicates that the user has a scheduled meeting or appointment compared to periods of time when the calendar data indicates that the user does not have a scheduled meeting or appointment. Alternatively, ambient data (210) associated with the receiving device (220) may take the form of information describing the current operating state of the receiving device (220), as a user of the receiving device (220) may be less likely to respond to messages (204) received during a period of time when the receiving device (220) is actively engaged in supporting a phone call compared to periods of time when the receiving device (220) is not actively engaged in supporting a phone call. The ambient data (210) associated with the receiving device (220) may take many other forms and may be used to evaluate whether the user of the receiving device (220) is likely to respond to the message (204), as an automated response may only be issued when the ambient data (210) indicates that a user of the receiving device (220) is less likely to respond to the message (204).

Readers will appreciate that a determination as to the likelihood that a user of the receiving device (220) will respond to the message (204) may take into account many different types of ambient data (210), which may be taken into account in a weighted or unweighted manner. For example, ambient data (210) indicating that a user of the receiving device (220) is actively engaged in a phone call may be given more weight than ambient data (210) indicating that a user of the receiving device (220) is moving at a high rate of speed, as the user may simply be a passenger in a car, train, bus, or in some other situation that would be unlikely to impair the user's ability to respond to the message (204). In such an example, an automated response may only be issued when the ambient data (210) indicates that the likelihood of a user of the receiving device (220) failing to respond to the message (204) exceeds some predetermined threshold.

The example method depicted in FIG. 2 also includes sending (218) an automated response (222) to the requesting device (202). In the example method depicted in FIG. 2, sending (218) an automated response (222) to the requesting device (202) may be carried out in response to affirmatively (216) determining to issue an automated response. The automated response (222) may be embodied, for example, as a text message that is sent from the receiving device (220) to the requesting device (202), as an electronic mail message that is sent from an electronic mail application executing on the receiving device (220) to an address associated with the sender of the message (204), and so on. In such an example, the automated response (222) may take the same format (e.g., via text, email, and so on) as the message (204) that was received (208) by the receiving device (220) or, alternatively, the receiving device (220) may be configured to respond to all messages in a single format. While additional details will be described below, readers will appreciate that the automated response (222) may include content that is constructed in such a way to be responsive to the content (206) contained in the message (204) that was received (208) by the receiving device (220). For example, if the message (204) that was received (208) by the receiving device (220) includes textual content such as “what time will you be home?,” the automated response (222) may include content that includes an estimated arrival time for a location that is believed to be the user's home, based on data gathered from a mapping application that is executing on the receiving device (220). Readers will appreciate that if the receiving device (220) determines that an automated response is not (214) to be issued, the receiving device (220) may wait for another message to be received.

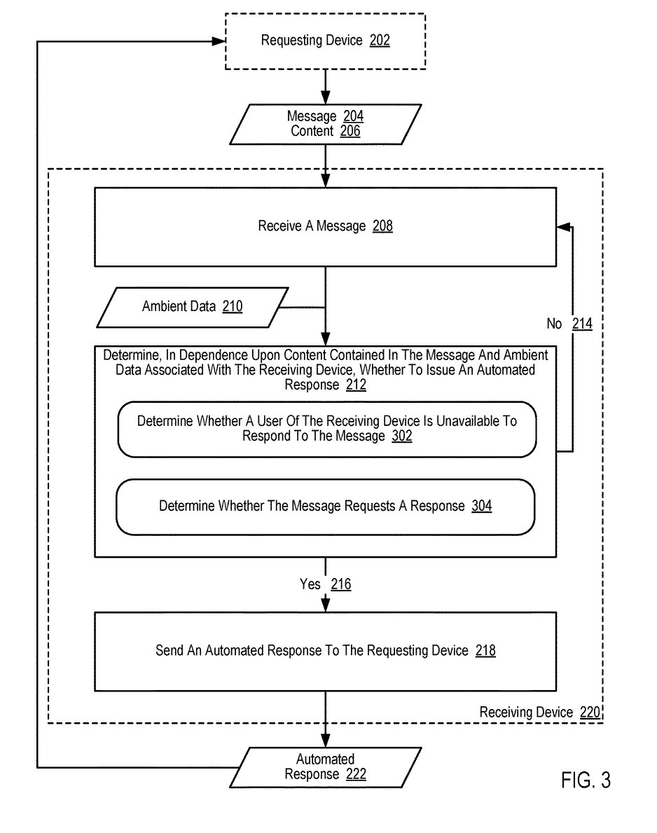

For further explanation, FIG. 3 sets forth a flow chart illustrating an additional example method for generating automatic responses to requests for information according to embodiments of the present disclosure. The example method depicted in FIG. 3 is similar to the example method depicted in FIG. 2, as the example method depicted in FIG. 3 also includes receiving (208) a message (204), determining (212) whether to issue an automated response, and sending (218) the automated response (222) to the requesting device (202).

In the example method depicted in FIG. 3, determining (212) whether to issue an automated response can include determining (302) whether a user of the receiving device (220) is unavailable to respond to the message (204). Determining (302) whether a user of the receiving device (220) is unavailable to respond to the message (204) may be carried out, for example, by gathering and evaluating information from one or more applications executing on the receiving device (220). The applications executing on the receiving device (220) may provide indications as to whether the user of the receiving device (220) is unavailable to respond to the message (204). For example, a calendar application may indicate that the user of the receiving device (220) had a scheduled appointment or meeting at the time that the message (204) was received (208), thereby indicating that the user of the receiving device (220) may be unavailable to respond to the message (204). Likewise, a video conferencing application executing on the receiving device (220) may indicate that the user of the receiving device (220) is actively engaged in a video conference, thereby indicating that the user of the receiving device (220) may be unavailable to respond to the message (204).

Determining (302) whether a user of the receiving device (220) is unavailable to respond to the message (204) may also be carried out, for example, by engaging one or more sensors or communications adapters in the receiving device (220), gathering information from such sensors or communications adapters, and evaluating information gathered from such sensors on the receiving device (220). For example, the receiving device (220) may engage one or more communications adapters such as a GPS receiver that is capable of sensing the location of the receiving device (220), the receiving device (220) may engage one or more a biometric sensor that can be used to determine whether a user of the receiving device (220) is proximate to the receiving device (220), the receiving device (220) may engage one or more a microphone that can be used to record audible data that may provide clues as to the user's current environment, or the receiving device (220) may engage one or more other sensors or communications adapters that may be included within or otherwise accessible to the receiving device (220). In such an example, information gathered from such sensors or communications adapters may be evaluated to determine (302) whether a user of the receiving device (220) is unavailable to respond to the message (204). For example, one or more biometric sensors may gather information indicating that the user of the receiving device (220) is proximate to the receiving device (220), thereby causing the receiving device (220) to determine (302) that the user of the receiving device (220) is most likely available to respond to the message (204). Alternatively, a microphone may gather information detecting the presences of multiple different voices, thereby causing the receiving device (220) to determine (302) that the user of the receiving device (220) is most likely unavailable to respond to the message (204) as the user of the receiving device (220) is engaged in a discussion of some sort.

Readers will appreciate that multiple inputs may be combined to increase the level of certainty associated with the determination that the user of the receiving device (220) is (or is not) unavailable to respond to the message (204). For example, if a calendar application executing on the receiving device (220) indicates that the user of the receiving device (220) has a scheduled meeting at the time that the message (204) was received (208) and a microphone on the receiving device (22) detects the presences of multiple different voices, the receiving device (220) may determine (302) that the user of the receiving device (220) is unavailable to respond to the message (204) as the user of the receiving device (220) is engaged in a meeting with a greater degree of certainty than would be possible with fewer inputs into such a determination. Likewise, if a calendar application executing on the receiving device (220) indicates that the user of the receiving device (220) does not have a scheduled meeting at the time that the message (204) was received (208) and one or more biometric sensors gather information indicating that the user of the receiving device (220) is proximate to the receiving device (220), the receiving device (220) may determine (302) that the user of the receiving device (220) is not unavailable to respond to the message (204) with a greater degree of certainty than would be possible with fewer inputs into such a determination.

In the example method depicted in FIG. 3, determining (212) whether to issue an automated response can also include determining (304) whether the message (204) requests a response. Determining (304) whether the message (204) requests a response may be carried out, for example, by translating the message into text (if necessary) and evaluating the textual representation of the message to determine whether the message requests a response. Evaluating the textual representation of the message to determine whether the message requests a response may be carried out, for example, through the use of natural language processing techniques that examine textual content to determine whether the textual content includes punctuation (e.g., a question mark), sentence structure (e.g., sentences that start with words such as “which,” “where,” “when,” “what”), phrases (e.g., “please let me know if,” “what time,” “do you know”), or other content that is indicative of a question being asked. In an alternative embodiment, the requesting device (202) may be configured to attach additional data or metadata to the message (204) that the receiving device (220) will interpret as a request for a response. The user of the requesting device (202) may be prompted, for example, to indicate whether a response is requested as part of the process of sending the message (204) to the receiving device (220). Readers will appreciate that determining (304) whether the message (204) requests a response may be carried out in other ways in accordance with embodiments of the present disclosure.

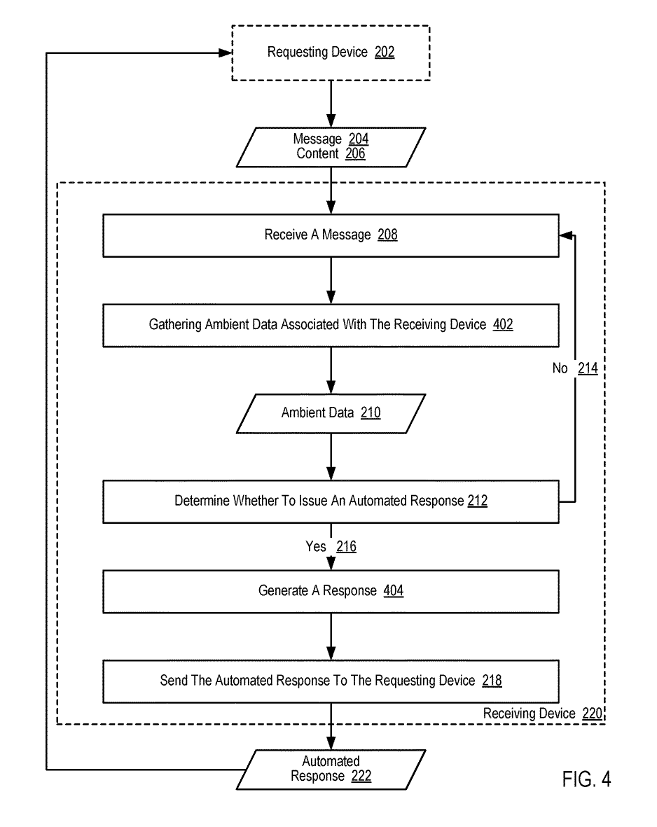

For further explanation, FIG. 4 sets forth a flow chart illustrating an additional example method for generating automatic responses to requests for information according to embodiments of the present disclosure. The example method depicted in FIG. 4 is similar to the example method depicted in FIG. 2, as the example method depicted in FIG. 4 also includes receiving (208) a message (204), determining (212) whether to issue an automated response, and sending (218) the automated response (222) to the requesting device (202).

The example method depicted in FIG. 4 includes gathering (402) ambient data (210) associated with the receiving device (220). Gathering (402) ambient data (210) associated with the receiving device (220) may be carried out, for example, by engaging one or more sensors or communications adapters in the receiving device (220), gathering information from such sensors or communications adapters, and evaluating information gathered from such sensors on the receiving device (220). For example, the receiving device (220) may engage one or more communications adapters such as a GPS receiver that is capable of sensing the location of the receiving device (220). Information gathered from such a communications adapter may be evaluated to generate ambient data (210) associated with the receiving device (220) such as, for example, ambient data (210) indicating that the user of the receiving device (220) is travelling at a relatively high rate of speed, ambient data (210) indicating that the user of the receiving device (220) is at a location where the user of the receiving device (220) would be unlikely to respond to a message, ambient data (210) indicating that the user of the receiving device (220) is at a location where the user of the receiving device (220) would be likely to respond to a message, and so on. Readers will appreciate that in other examples, gathering (402) ambient data (210) associated with the receiving device (220) may be carried out by simply examining the state of one or more sensors or communications adapters in the receiving device (220). For example, if the state of a telecommunications adapter that enables the receiving device (220) to couple to a telecommunications network indicates that the telecommunications adapter is actively sending and receiving voice data, ambient data (210) indicating that the user of the receiving device (220) is on a phone call may be generated. Likewise, if the state of a video camera on the receiving device (220) and a microphone on the receiving device (220) indicates that both sensors are active, and an data communications adapter on the receiving device (220) that couples the receiving device (220) to an IP network is actively sending and receiving at least a threshold amount of data, ambient data (210) indicating that the user of the receiving device (220) is on a video call may be generated. Readers will appreciate that

Gathering (402) ambient data (210) associated with the receiving device (220) may also be carried out, for example, by gathering information from one or more applications executing on the receiving device (220). For example, information from a calendar application executing on the receiving device (220) may be gathered to generate ambient data (210) indicating that the user of the receiving device (220) does or does not have additional commitments (e.g., meetings, appointments) at the time that the message (204) is received (208). Likewise, information from a gaming application, social networking application, internet browsing application, or other application executing on the receiving device (220) may be gathered to generate ambient data (210) indicating that the user of the receiving device (220) is actively engaged in an activity (e.g., playing a game, web surfing) that is associated with high user availability. Readers will appreciate that gathering (402) ambient data (210) associated with the receiving device (220) may be carried out in many other ways, including receiving such information from other devices. For example, if the receiving device (220) does not include a GPS receiver but the receiving device (220) does include a Bluetooth adapter (or other data communications adapter) that may be used to couple a mapping system such as a navigation system in an automobile, the automobile may communication GPS data to the receiving device (220) via the Bluetooth connection.

The example method depicted in FIG. 4 also includes generating (404) the automated response (222). Generating (404) the automated response (222) may be carried out, for example, by determining what information is requested in the message (204) and gathering the information that is requested in the message (204). Determining what information is requested in the message (204) may be carried, for example, by applying natural language processing techniques to a textual representation of the content (206) contained in the message (204). Such natural language processing techniques may be used to identify specific words and phrases (e.g., “what time will be home,” “when did you leave the office,” “have you called John”) that are indicative of some particular information that is being requested. In such an example, once the receiving device (220) has determined what information is requested in the message (204), the receiving device (220) may gather the information that is requested in the message (204). The receiving device (220) may gather the information that is requested in the message (204) by examining data that is maintained by the receiving device (220). For example, if the message (204) that was received (208) by the receiving device (220) includes content (206) that includes the query of “have you called John?,” the receiving device (220) may examine a call log that is maintained by the receiving device (220) to determine whether a call was received from or placed to a contact whose first name is “John,” “Jonathan,” and so on. In such an example, if a call was received from or placed to such a contact, an automated response (222) may be generated (404) which states that “a call to John Smith was placed at 3:42 PM” by utilizing information maintained by the receiving device (220) in a call log and a contacts list.

Readers will appreciate that gathering the information that is requested in the message (204) may also be carried out through the use of one or more sensors in the receiving device (220), through the use of one or more data communications adapters in the receiving device (220), through the use of one or more applications executing on the receiving device (220), and so on. For example, if the message (204) that was received (208) by the receiving device (220) includes content (206) that includes the query of “what time will you be home?,” the receiving device (220) may utilize a GPS transceiver within the receiving device (220), a mapping application executing on the receiving device (220), and data retained by the receiving device that identifies the address of the user's home, to generate a predicted arrival time based on factors such as the user's current location, traffic conditions along the route that the user would need to take to go home, and so on.

In the example method depicted in FIG. 4, the automated response (222) may be generated (404) in dependence upon the content (206) contained in the message (204). Readers will appreciate that the automated response (222) may be generated (404) in dependence upon the content (206) contained in the message (204), for example, because the content (206) contained in the message (204) is used to determine what information is requested in the message (204). For example, an automated response (222) that is generated (404) in response to a message (204) whose content (206) includes text which reads “what time will you be home?” will be different than an automated response (222) that is generated (404) in response to a message (204) whose content (206) includes text which reads “did you pick up the dry cleaning?” As such, in order for the automated response (222) to be responsive to the message (204), the content (206) contained in the message (204) must be examined.

In the example method depicted in FIG. 4, the automated response (222) may also be generated (404) in dependence upon data maintained by the receiving device (220). Readers will appreciate that the automated response (222) may be generated (404) in dependence upon data maintained by the receiving device (220), for example, because the data that is maintained by the receiving device (220) may be used in the automated response (222) itself. For example, an automated response (222) that is generated (404) in response to a message (204) whose content (206) includes text which reads “did you call Dave?” may include a response that includes information pulled from a call log maintained on the receiving device (220).

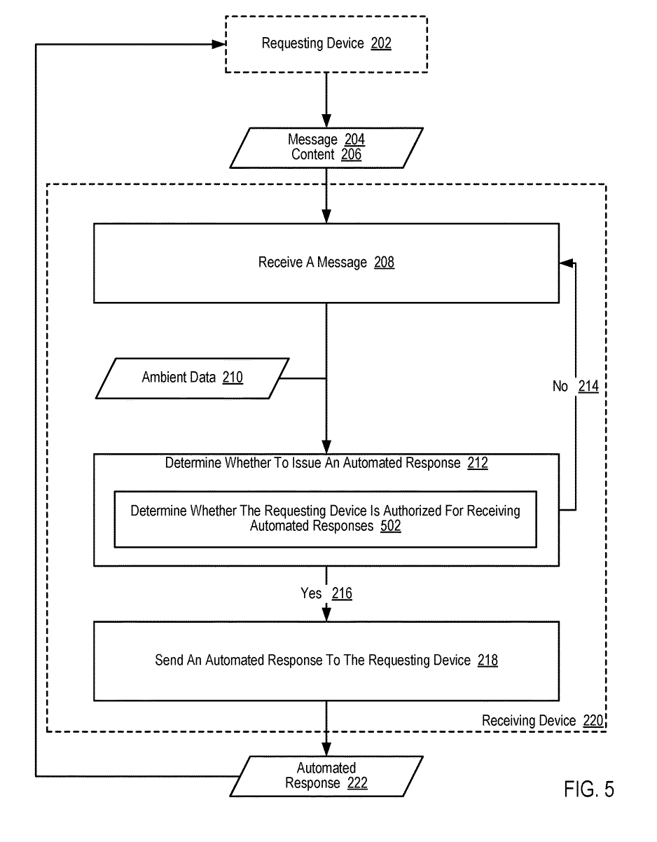

For further explanation, FIG. 5 sets forth a flow chart illustrating an additional example method for generating automatic responses to requests for information according to embodiments of the present disclosure. The example method depicted in FIG. 5 is similar to the example method depicted in FIG. 2, as the example method depicted in FIG. 5 also includes receiving (208) a message (204), determining (212) whether to issue an automated response, and sending (218) the automated response (222) to the requesting device (202).

In the example method depicted in FIG. 5, determining (212) whether to issue an automated response can include determining (502) whether the requesting device (202) is authorized for receiving automated responses. Determining (502) whether the requesting device (202) is authorized for receiving automated responses may be carried out, for example, by the requesting device (202) including a device identifier (e.g., a phone number) in the message (204) or the receiving device (220) otherwise detecting a device identifier for the requesting device (202). In such an example, the receiving device (220) may maintain a list of devices that are authorized for receiving automated responses and may therefore compare the device identifier for the requesting device (202) to the list of devices that are authorized for receiving automated responses to determine (502) whether the requesting device (202) is authorized for receiving automated responses.

Readers will appreciate that in some embodiments, the requesting device (202) may request an automatic response, such that the message (204) is not even presented to the user of the receiving device (220). In such an embodiment, if the requesting device (202) is authorized for receiving automated responses, the receiving device (220) may proceed to respond to the message (204) without even presenting such a message (204) to the user of the receiving device (220). For example, the requesting device (202) may send a message (204) that includes the phrase “where are you?” along with a special identifier indicating that an automatic response is requested. In such an example, if the requesting device (202) is authorized for receiving automated responses, the receiving device (220) may send an automatic response that includes information such as GPS coordinates for the receiving device (220), an identification of a known location (e.g., home, work, Billy's school) whose GPS coordinates match GPS coordinates for the receiving device (220), an identification of a closest intersection to the receiving device (220) as identified by a mapping application executing on the receiving device (220), and so on.

Readers will appreciate that although the example methods described above are depicted in a way where a series of steps occurs in a particular order, no particular ordering of the steps is required unless explicitly stated. Example embodiments of the present disclosure are described largely in the context of a methods and devices for generating automatic responses to requests for information. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the example embodiments described in this specification are oriented to software installed and executing on computer hardware, nevertheless, alternative embodiments implemented as firmware or as hardware are well within the scope of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method comprising:
receiving, by a receiving device from a requesting device, a message;
determining, in dependence upon content contained in the message and ambient data associated with the receiving device, whether to issue an automated response; and
responsive to determining to issue an automated response, sending the automated response to the requesting device.

2. The method of claim 1 wherein determining whether to issue the automated response further comprises determining whether a user of the receiving device is unavailable to respond to the message.

3. The method of claim 1 wherein determining whether to issue the automated response further comprises determining whether the message requests a response.

4. The method of claim 1 further comprising generating, in dependence upon the content contained in the message, the automated response.

5. The method of claim 1 further comprising generating, in dependence upon data maintained by the receiving device, the automated response.

6. The method of claim 1 further comprising gathering ambient data associated with the receiving device.

7. The method of claim 1 wherein determining whether to engage the automated response system further comprises determining whether the requesting device is authorized for receiving automated responses.

8. A computing device, the computing device comprising a computer processor, a computer memory operatively coupled to the computer processor, the computer memory having disposed within it computer program instructions that, when executed by the computer processor, cause the computing device to carry out the steps of:
receiving, from a requesting device, a message;
determining, in dependence upon content contained in the message and ambient data associated with the computing device, whether to issue an automated response; and
responsive to determining to issue an automated response, sending the automated response to the requesting device.

9. The computing device of claim 8 wherein determining whether to issue the automated response further comprises determining whether a user of the computing device is unavailable to respond to the message.

10. The computing device of claim 8 wherein determining whether to issue the automated response further comprises determining whether the message requests a response.

11. The computing device of claim 8 further comprising computer program instructions that, when executed by the computer processor, cause the computing device to carry out the step of generating, in dependence upon the content contained in the message, the automated response.

12. The computing device of claim 8 further comprising computer program instructions that, when executed by the computer processor, cause the computing device to carry out the step of generating, in dependence upon data maintained by the computing device, the automated response.

13. The computing device of claim 8 further comprising computer program instructions that, when executed by the computer processor, cause the computing device to carry out the step of gathering ambient data associated with the computing device.

14. The computing device of claim 8 wherein determining whether to engage the automated response system further comprises determining whether the requesting device is authorized for receiving automated responses.

15. A computer program product, the computer program product disposed upon a non-transitory computer readable medium, the computer program product comprising computer program instructions that, when executed, cause a computing device to carry out the steps of:
receiving, from a requesting device, a message;
determining, in dependence upon content contained in the message and ambient data associated with the computing device, whether to issue an automated response; and
responsive to determining to issue an automated response, sending the automated response to the requesting device.

16. The computer program product of claim 15 wherein determining whether to issue the automated response further comprises determining whether a user of the computing device is unavailable to respond to the message.

17. The computer program product of claim 15 wherein determining whether to issue the automated response further comprises determining whether the message requests a response.

18. The computer program product of claim 15 further comprising computer program instructions that, when executed, cause the computing device to carry out the step of generating, in dependence upon the content contained in the message, the automated response.

19. The computer program product of claim 15 further comprising computer program instructions that, when executed, cause the computing device to carry out the step of generating, in dependence upon data maintained by the computing device, the automated response.

20. The computer program product of claim 15 further comprising computer program instructions that, when executed, cause the computing device to carry out the step of determining whether the requesting device is authorized for receiving automated responses.
